(19) United States
(12) Patent Application Publication
(10) Pub. No.: US 2020/0193334 A1
(43) Pub. Date: Jun. 18, 2020

(54) Method and System for Setting a Performance Event

(71) Applicant: Shaye David Mann, Phoenix, AZ (US)

(72) Inventor: Shaye David Mann, Phoenix, AZ (US)

(21) Appl. No.: 16/716,468

(22) Filed: Dec. 16, 2019

Related U.S. Application Data
(60) Provisional application No. 62/780,336, filed on Dec. 17, 2018.

(51) Int. Cl. G06Q 10/02; G06Q 30/02; G06Q 10/04

(52) U.S. Cl. CPC G06Q 10/02; G06Q 30/0213; G06Q 10/04; G06Q 30/0208

(57) ABSTRACT

A method and system for setting a performance event includes collecting information from fans regarding their interest in a performance, and determining whether or not to set the performance and/or determining a parameter of the event for setting a performance based on the received responses.

### CROSS-REFERENCE TO RELATED APPLICATIONS

This application claims benefit to U.S. Provisional Application No. 62/780,336 filed Dec. 17, 2018, which is incorporated by reference herein in its entirety.

### BACKGROUND

Entertainment events, such as concert shows, theatrical performances, comedy shows, etc., typically involve planning for and committing to the performance prior to selling tickets. In many cases, this may necessitate contractual commitment(s) and/or other investments on the part of the artist their representative and/or partners, such as booking a location, engaging various services, etc. This may entail certain risks such as performing to unsatisfactory audience levels and/or less than acceptable revenues, investing more than financially reasonable (e.g. booking a much larger venue then needed), and/or missing lucrative performance opportunities where fan demand is high. An improved system is therefore needed.

### SUMMARY

According to various embodiments, the disclosed subject matter provides a system and method that allows artists to ensure a pre-defined amount of interest and/or ticket commitments prior to setting a performance event (e.g. concert), and/or allows fans to request/petition any given artist to hold a performance (e.g. play a concert), in any given locale (e.g. city, town) and/or around a particular time period, date(s), and/or season.

Various advantages of the disclosed system and method include reducing, or even eliminating, the risk of announcing/planning/staging a concert to a “half empty house,” i.e. unsatisfactory audience levels/ticket sales. According to various embodiments, the disclosed system and method may allow artists to maintain or set their own acceptable predetermined level of interest, or ticket sales prior to committing to a performance (e.g. announcing or setting a show). In some embodiments, the disclosed system and method may allow artists to satisfy the demands of their fans, and play at locales (e.g. cities, towns, etc.), venues, and/or time periods they may not otherwise play due to uncertainty of potential ticket sales. This can also help bands increase their exposure and visibility. In some embodiments, the disclosed method/ system may incentivize and/or increase fan interest in a performance.

In some embodiments, the disclosed system/ method may allow fans to indicate and communicate their interest in attending a performance by a specific artist. In embodiments, this may entail enabling/ allowing fans to actually request a concert. Thus fans in smaller cities or less populated areas may be provided with the opportunity or possibility of seeing artists (e.g. music bands) locally, rather than having to travel long distances. Additionally, the disclosed system/method may give fans more opportunities to see their favorite acts.

Further advantages may include reducing the problem of tickets being sold out (i.e. to scalpers) with fans losing out on the opportunity to purchase tickets from a ticket sales and distribution company (e.g. Ticketmaster) dealing directly with the artist.

Thus, the disclosed method and system is designed to enhance the overall entertainment experience for both the artist and fan.

According to various embodiments, disclosed is a method for setting a performance event, which may comprise: determining weather to set the performance event and/or a parameter of the performance event, based on information collected from fans regarding fan interest related to the performance event, wherein said information regarding fan interest is collected in response to an inquiry or a campaign related to the performance event, and wherein the inquiry or campaign is publicized via at least one electronic communication platform. In embodiments, the method further comprises enabling and/or incentivizing a user of the method to set an inquiry or campaign and/or to advertise regarding interest in the performance event. In embodiments, the method further comprises collecting said information regarding fan interest. In further embodiments, a user may be a fan, a performing artist(s) or a representative of the performing artist(s), and/or a third party who has a business interest in said performance event. In embodiments, the method further comprises engaging fans and obtaining commitments towards ticket purchases should a performance be set. In embodiments, the method further comprises creating and/or publicizing the NPP inquiry, via at least one of a network communication forum, individualized communication forum, or combination thereof. In embodiments, the method further comprises incentivizing merchandise sales related to the performance event via enabling users to access a merchandise sales platform through said at least one electronic communication platform. In some embodiments, said inquiry or a campaign is publicized via social media of at least one user, individualized communication forum, network forum, or combinations thereof. In further embodiments, said inquiry or a campaign is advertised via third party forums.

Also disclosed according to various embodiments is an electronic communication network forum configured for implementing a method of setting a performance event, the method comprising: collecting information regarding fan interest related to a tentative or potential performance event via at least one electronic communication platform, wherein said collecting information comprises creating an inquiry regarding the performance event, and publicizing the inquiry; and determining, based on information received in response to said inquiry, whether to set the performance event, and/or a parameter of the performance event.

Also disclosed according to various embodiments, is method for setting a performance event, comprising: guiding the creation of a campaign or inquiry, said campaign or inquiry being related to a tentative performance event, wherein said campaign or inquiry is publicized, wherein responses to said campaign or inquiry are collected, and wherein a determination as to whether to set the tentative performance event and/or a parameter of the tentative performance event is determined based on the collected responses to said campaign or inquiry, and wherein the inquiry or campaign is created and publicized via at least one electronic communication platform.

In some embodiments, the method further comprises enabling a user or participant to create said inquiry or campaign and/or to advertise regarding interest in the performance event, wherein said user may be a fan, a performing artist(s) associated with the performance event or a representative thereof, a third party who has a business interest in said performance event, or combinations thereof. In some embodiments, the method further comprises obtaining commitments towards ticket purchases should the tentative performance event be set, wherein said commitments may comprise full or partial payment for a ticket, providing payment information which can be used for collecting payment should the performance event be scheduled, or other obligating criteria.

In some embodiments, the method further comprises offering incentives for commitments towards ticket purchases, said incentives comprising discounted tickets, early ticket purchase options, better seats, coupons for purchases at the performance event, such as food and drink, ability to purchase event related merchandise, or combinations thereof. In some embodiments, the method further comprises creating and publicizing the campaign or inquiry, via at least one of a network communication forum, individualized communication forum, or combination thereof. In some embodiments, the method further comprises incentivizing merchandise sales related to the performance event via enabling users to access a merchandise sales platform through said at least one electronic communication platform. In further embodiments, the inquiry or a campaign is publicized via social media of at least one user, individualized communication forum, network forum supported by a host entity, a third party network forum or combinations thereof.

Further disclosed, according to various embodiments, is a system for setting a performance event comprising providing an electronic communication network forum configured for implementing a method comprising: collecting information regarding fan interest related to a potential performance event via at least one electronic communication platform, wherein said collecting information comprises creating an inquiry or campaign regarding the performance event, and publicizing the inquiry or campaign, said inquiry or campaign configured to obtain information regarding interest in the performance event; and determining, based on information received in response to said inquiry or campaign, whether to set the performance event, and/or a parameter of the performance event.

In some embodiments, said electronic communication network forum enables users to purchase merchandise related to the performance event. In some embodiments, the method further comprises enabling a user of the forum to create and/or advertise the inquiry or campaign, subject to meeting qualifying criteria for doing so, wherein said qualifying criteria comprises at least one of: approval by a performing artist associated with the performance event, or representative thereof; membership status of the user; commitment of the user to purchase a ticket concerning the performance event; providing personal information by the user, approval of the host entity; payment of fee; and combinations thereof.

[symbol]

A method for setting a performance event, comprising:

guiding the creation and/or publication of a campaign or inquiry via at least one electronic communication platform, said campaign or inquiry being related to a tentative performance event; collecting responses to said campaign or inquiry; and presenting said responses to at least one entity or person(s) having an interest in the tentative performance event, wherein said entity or person(s) having an interest in the tentative performance event comprises a performing artist associated with the performance event and/or representative thereof, a party having a business interest in the tentative performance event, members of the general public including fans of the performing artist, or combinations thereof.

In some embodiments, a determination as to whether to set the tentative performance event and/or a parameter of the tentative performance event is determined based on the collected responses to said campaign or inquiry. In some embodiments, the method further comprises obtaining commitments towards ticket purchases should the tentative performance event be set.

In some embodiments, the method further comprises offering incentives for commitments towards ticket purchases. In some embodiments, guiding the creation and/or publication comprises providing an electronic communication platform through which a user seeking to create said campaign or inquiry may provide information related to the campaign or inquiry for the purpose of having the campaign or inquiry publicized. In some embodiments, the method further comprises publicizing the campaign or inquiry through at least one electronic communication forum including a network communication forum controlled by a host entity.

In some embodiments, the method further comprises publicizing the campaign or inquiry through email, text messaging, social media, pop-up ads, or combinations thereof, and wherein publicizing may be performed by said host entity, a creator of the campaign or inquiry, and/or other entity with an interest in the performance event. In some embodiments, the method further comprises obtaining approval from a performing artist associated with the performance event and/or representative thereof, prior to publicizing the inquiry or campaign. In some embodiments, the method further comprises presenting said responses via said at least one electronic communication platform, wherein the results are viewable by fans, and wherein the results are presented as they are received in real time or periodically. In some embodiments, the campaign or inquiry provides a response goal which serves to obligate the performing artist associated with the performance event and/or representative thereof, to set a performance should the response goal be met.

### BRIEF DESCRIPTION OF THE DRAWINGS

The drawings described herein are for illustration purposes only and are not intended to limit the scope of the present disclosure in any way. The present disclosure will become more fully understood from the detailed description and the accompanying drawings wherein:

FIG. 1 shows a method and system for setting a performance event, according to a first embodiment.

FIG. 2 shows a method and system for setting a performance event, according to a second embodiment.

FIG. 3 shows a method and system for setting a performance event, according to a second embodiment.

[symbol]

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step.

Unless stated otherwise, the term artist(s)/performing artist(s) shall include individual and group performers, their partners, investors, associates, corporations, and/or any other person or entity who may otherwise have a financial interest in performances held by the artist/performer(s).

Unless stated otherwise, the term fan(s) may include members of the general public, users and/or established participants of the disclosed system, and/or any persons having interest in a performance.

The present disclosure provides a system and method for gauging fan interest prior to planning for and contractually committing to a performance event, such as concert shows, theatrical performances, comedy shows, etc., which is desirable and beneficial to both the artist and their fans.

Various benefits/ advantages of the disclosed system and method include discouraging a performance to a less than satisfactory audience. Additional or alternate benefits/ advantages may include enabling evaluation of fan interest before announcing a performance. Additional or alternate benefits/ advantages may include enabling the fans, performers, and/or affiliates to create a campaign or petition for a performance. For example, a concert performer may create a campaign for fans to show support or drum up fan interest; fans may create a petition requesting a performer to perform and/or appear in a certain city; performers may set a minimal amount of required commitments/ ticket sales prior to setting a show. Additional or alternate benefits/advantages may include

Performance events typically involve planning for and committing to the performance prior to selling tickets. In many cases, this may necessitate contractual commitment(s) and/or other investments on the part of the artist their representative and/or partners, such as booking a location, engaging various services, etc.

However, it may be difficult for performing artist and/or their representatives to accurately gauge fan interest/ demand for a given time and location. Thus, there may be a risk to the artist in announcing a show prior to knowing how many tickets will sell. The uncertainty may result in performing to unsatisfactory audience levels and/or less than acceptable revenues, investing more than financially reasonable (e.g. booking a much larger venue then needed), and/or missing lucrative performance opportunities where fan demand is high.

The disclosed system and method 100 for setting a performance event comprises determining whether or not to set the performance, gauging fan interest, and/or determining at least one parameter (e.g. venue, schedule, pricing, etc.) for setting the event based on information collected from fans regarding interest in a performance, wherein said information may be collected via an inquiry or petition, and wherein the inquiry or petition is publicized via at least one electronic communication forum. In some embodiments, the method/ system may comprise enabling and/or incentivizing fans or other third parties to set an inquiry or campaign and/or advertise on behalf of a performing artist. In some embodiments, the method/ system may comprise engaging fans and obtaining commitments towards ticket purchases should a performance be set.

In some embodiments, the method 100 may incentivize ticket purchase and promote fan enthusiasm, while increasing certainty of expected success level of a performance. In some embodiments, the method may be used to sell tickets directly through a platform hosting the method 100.

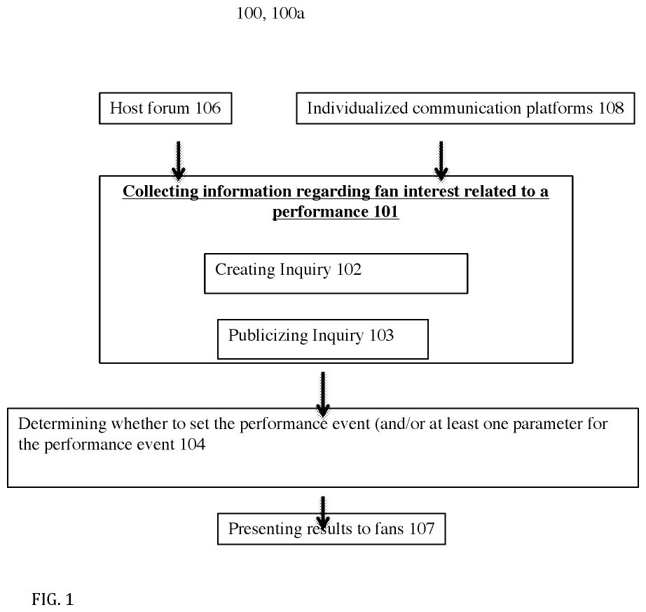

In FIG. 1, a method and system 100a, according to a first embodiment of the disclosed method and system 100 for setting a performance event is disclosed. In embodiments, method 100/100a may comprise a step 101 of collecting information regarding fan interest related to a tentative performance, i.e. a new potential performance (NPP). In embodiments, step 101 may be conducted prior to setting a performance event. The method/system 100 may further comprise a step 104 of determining, based on the information regarding fan interest, whether to set the performance event (i.e. whether or not a performance will take place), and/or at least one parameter for the performance event, based on the collected information regarding fan interest. A performance event parameter may comprise, for example, location(s) of the performance event, scheduling date(s)/ time(s) of the performance event, and/or ticket price for the performance event. In embodiments, step 101 may further comprise a substep 102 of creating an inquiry or enabling an inquiry to be created regarding the performance “NPP inquiry,” and a substep 103 of publicizing or enabling publication of the NPP inquiry, wherein fans and/or the public at large may provide responses to the NPP inquiry. According to various embodiments, at least step 101, including sub-steps 102, 103 may be performed via an electronic communication platform such as an App, webpage, website, email, text messaging, and the like, which may operate via at least one an electronic device controlled by a user.

### Creating NPP Inquiry

In embodiments, the NPP inquiry may be created, according to step 102, by a performing artist(s), or a representative of the performing artist(s) (e.g. manager, agent, corporate entity representing the performing artist, etc.). The performing artist may be, for example, musician, musical band, comedian, actor, etc. desiring to hold one or more performance(s) or a tour. Such artist/representative may be interested in gauging fan interest in attending the performance, determining location(s) and/or date(s) which would maximize fan attendance and/or revenue, arousing fan interest, etc. In some embodiments, the NPP inquiry may be created by a third party having a business interest in the performance event. Such third party may be a business entity who may profit indirectly from the performance and/or high attendance. This may include, for example, an owner/operator of a performance venue (where the performance may take place), or businesses surrounding the venue (e.g. bars restaurants); event merchandise sales (who may profit by selling fan merchandise), etc. In some embodiments, the NPP inquiry may be created by a fan, or member of the public, who may desire to demonstrate or incite interest in order to incentivize a performing artist to hold a performance, and/or to perform at a certain locale, time period, etc.

### Electronic Communication Forum for Implementing Method 100

In embodiments, creating and/or publicizing the NPP inquiry, according to steps 102 and/or step 103, may be executed via at least one electronic communication platform comprising a network communication forum (host forum 106) controlled (directly or indirectly) by a host entity. In embodiments, the network communication forum may be an App, website, webpage, social media page, and/or via individual electronic communications accounts (individualized communication forum 108), such as email, text, individual social media accounts, and the like.

### Host Forum

In embodiments, host forum 106 may provide a GUI accessible via an electronic device operated by a user, and may run software/programming instructions for implementing method 100. In embodiments, the method 100 may further be controlled/ overseen via a host entity, (which may operate via at least one host server) in communication with the host forum 106.

In embodiments, the host forum may be dedicated solely to the implementation of method 100. In other embodiments, the host forum may carry out other functions besides method 100 (e.g. ticket sales, blogging, personal posts, online merchandise sales, etc.). In some embodiments, the host forum may be associated with entertainment or performances in general, ticket sales, a specific performer (e.g. a “fan page”), type of performance and/or genre (i.e. music, rock music, classical music, comedy, theatrical, dance, ballet, etc.), and/or location or venue (i.e. LA, the Hollywood Bowl, Broadway, etc.), etc. In some embodiments, the NPP Inquiry may be posted on various forums supporting advertising content, such as social media sites, various websites allowing pop-up or other advertising or promotions (e.g. Groupon®, Facebook®, Amazon®, etc.), and the like, which may link to the host forum 106 and/or host entity.

In some embodiments, the NPP inquiry may be publicized by targeted advertising/communication to particular fans based on fan targeting criteria (i.e. individualized targeting criteria associated with each fan). Such targeted advertising may be, for example, through email, text, pop-up ads, social media account, etc.). Such targeting criteria may be based on a fan's previous purchase or show attendance history, expressed interest in a particular type of performance, demographics, etc. In some embodiments, fans may be required or incentivized to provide personal information which may be used in NPP targeting. For example, fans may be asked to provide personal information as a prerequisite for receiving NPP inquiries, accessing an NPP associate web page, receiving performance notifications, or other incentives such as ticket discounts, better seating options, prizes, raffle entries, coupons, etc.

In some embodiments, fans themselves may advertise the inquiry individualized communication platforms 108. In embodiments, fans may be given incentives to do so, such as ticket discounts or other rewards based on referrals, or referrals which result in ticket purchases., etc.

In embodiments, the method 100 may further comprise compiling electronic destination IDs such as emails, phone numbers, social media accounts of users for publicizing via individualized communication platforms 108, which may be in addition to or instead of communication through the host forum 106. In some embodiments, potential fans may be given incentive for providing their destination ID(s) and/or agreeing to receive NPP inquiry communications (e.g. discounted fees, early ticket purchase options, better seating options, access to particular information, prizes, coupons, raffle entries, etc.).

In some embodiments, access to the host forum 106 may be limited to member users (which may include performing artists and other parties with a business interest in the performance, as well as fans), wherein membership may be based on payment of a fee, commitment to purchase tickets, past purchase or performance attendance, providing personal information, etc. In some embodiments, access to the host forum 106 may be publically unrestricted.

### Creating and Publicizing NPP Through NPP Venue

In embodiments, NPP inquiry may be created by the host entity, preforming artist, and/or fans. In embodiments, users may communicate the desired to create/ publicize an NPP inquiry, and desired contents of the inquiry though a webpage/website host forum, or by messaging, e.g. email, text, phone call, mail, etc. the host entity.

In embodiments, the host entity may provide guidance as to how to submit an NPP inquiry for publication and a channel for users to convey an inquiry for creation, consideration and/or publication.

For example, the host forum may provide a form or questionnaire, accessible through the host forum 106, which may include fields which a user/ creator can fill out. In some embodiments, the NPP Inquiry may provide a link, email address, etc., through which users may send requests to create and publicize an NPP inquiry, with desired content of the inquiry.

In some embodiments, creation and/or publication of the NPP inquiry may be limited to the performing artist/ representatives regarding whom the inquiry concerns, and/or third parties approved by the artist/ representative. In some embodiments, creation/ publication may be open to member of the public and/or fans. In some embodiments, creation and/or publication of a created inquiry may be subject to certain conditions/ requirements by the host, such as payment of a fee, user membership/ enrollment, host approval, performer approval, prior attendance at an event, agreement to purchase tickets, etc.

In embodiments, publicizing may be performed by the host entity itself (e.g. by posting on the host forum, emailing, texting, sharing on social media, etc.). In some embodiments, the performing artist(s) and/or the fans themselves may publicize the NPP Inquiry (e.g. through social media, personal webpage, etc.).

### Content of NPP Inquiry

According to various embodiments, the NPP inquiry may request information regarding fan interest in a potential performance, which may be general or specific. Such questions may concern, for example, interest, preferred option(s), and/or evaluation(s), which may concern a particular artist(s)/ performance(s), ticket price, location, performance schedule, opening act, etc. In embodiments, the NPP inquiry may include one or more questions requesting a yes/no response, multiple choice selection, quantitative evaluation, and/or general comments.

As non-limiting examples, such questions may include: are you interested in seeing X artist? What kind of performance are you interested in seeing? Are you interested in seeing X artist perform at Y location? Would you be able to attend a performance during the month of Z? Which performer out of A, B, and C would you most be interested in seeing? How much would you pay to see performer Z? Please provide your comments regarding location L. Who would you prefer for an opening act?, etc.).

The NPP inquiry may also include follow-up questions based on the specific response(s) provided. For example, the NPP inquiry may include a yes/no questions as to whether the fan is interested in seeing a certain artist or group of artists; if a ‘yes’ answer is given, a follow-up question may be presented concerning a preferred venue, acceptable ticket price, etc. Or, a ‘no’ response may be followed up with request for comments as to why the fan is not interested.

Such information collected may be used to determine the best options/ criteria for setting a show, a series of shows (e.g. tour), and the like.

In some embodiments, the NPP inquiry may provide an option of purchasing tickets, entering into a contractual obligation (commitment) to purchase tickets should the performance be set, and the like. For example, if a fan agrees to purchase tickets should the performance be set, the payment may be exacted from an account which may be electronically stored, if the performance is set. In embodiments, actual payment or partial payment (e.g. collateral) may be solicited from the fan for confirming interest, reserving a ticket, and/or purchasing/ reserving an optional ticket, wherein payment may be refunded if the show does not go on as scheduled. In some embodiments, the fan may be offered an incentive for purchasing tickets or entering into a commitment to do so (e.g. committing to the provisional purchase of a ticket(s)) in response to the NPP inquiry. These incentives may include, for example, discount for early ticket purchase, discount on event related merchandise, better seat options, backstage passes, coupons for food/drinks, various prizes, free raffle tickets, etc.).

In embodiments, responses received to the NPP inquiry may be presented to the host, creator of the inquiry, performing artist and/or affiliates, for making a determination as to whether to set the performance, and/or at least one parameter of the performance, according to step 104. In embodiments, results may be presented as they are received/ collected in real time, and/or as they are collected/ compiled periodically. In embodiments, the responses may be compiled and stored on a data storage medium (e.g. file, database, compressed file, etc.), of the host entity. In embodiments, the results may be complied continuously, in real time, periodically, etc. In embodiments, the compiled results or portion thereof, may be processed for interpretation by the host entity.

In some embodiments, the results or partial results may be presented to fans (e.g. as they are received in real time, periodically, etc.). In embodiments, the results may be publicized communicated or displayed via numerical, graphical, and/or textual representation, and the like. For example, the host forum may display a meter depiction of how many affirmative responses have been received, how much more responses are needed or the likelihood of the performance being set, a chart indicating the number of responses for alternate preferences (e.g. artist X vs. artist Y), etc.

In embodiments, the performing artist(s) or representative thereof may set an obligation criteria or goal (response goal), which may serve to contractually obligate the artist to perform should the obligation criteria be met. Such contractual obligation may be to the committing fans themselves, and/or other third party. The obligating criteria may be, for example, a set number of fan commitments to attend a show, a set profit amount resulting from said fan commitments, etc. In other embodiments, the set criteria may not be contractually obligating upon the artist, but just set as a gauge and/or to drum up fan enthusiasm.

In some embodiments, the obligating criteria may be communicated to the fans. In further embodiments, responses from fans may be shown to other fans as they are received, such that each fan will know the total fan response prior to determining whether or not a performance will take place.

For example, say a music group commits to perform upon 10,000 commitments to attend their show, fans may view on the host forum and/or receive email updates regarding how many commitments have been received, and therefore how many commitments are needed for the show to take place.

According to another example, a band may use an NPP inquiry to gauge fan interest, and determine whether or not to set a performance (in a given locale and/or at a certain time period), based on the number of fans that “RSVP” (which may be with or without commitment). The band may keep the responses internally at whatever comfort level, knowing not everyone that RSVPs will follow-up and buy a ticket, wherein that comfort level is how the band will set the baseline number of RSVP's they want.

In other examples, fans may be able to see the band's target number, as well as the number of RSVP's to date, and how many are left to a show commitment. Such information may further be shared on all forms of social media, and bands may have the option of paying to boost ads on those mediums to increase exposure to their campaign. Additionally, the band may opt to commit to a show if a certain baseline number of fans commit to attending the performance. The host entity may solicit credit card information or link with other forms of payment, which may not be charged unless and until a band announces a show. As such, committed fans may have the opportunity to secure tickets even before a show is announced.

In some examples, the performing artist(s) can offer incentives. For example: a band can offer the first, say 500 fans that commit to attending the show VIP passes or special ticket discounts, or other incentive.

In further examples, the performing artist and/or fan may determine their own contractual terms, or such terms may be flexible. For instance, fans may have the option to fully commit to a show, to commit only if the show is at a specific time/ time period (e.g. on a weekend, or on specific nights), etc.

As will be apparent to one skilled in the art, information collected from fans may be used to determine optimal criteria (e.g. schedule, venue, etc. which will likely generate most revenue) for a show or shows. In some embodiments, a computer program, algorithm, or mathematical equation may be used for determining such optimal criteria.

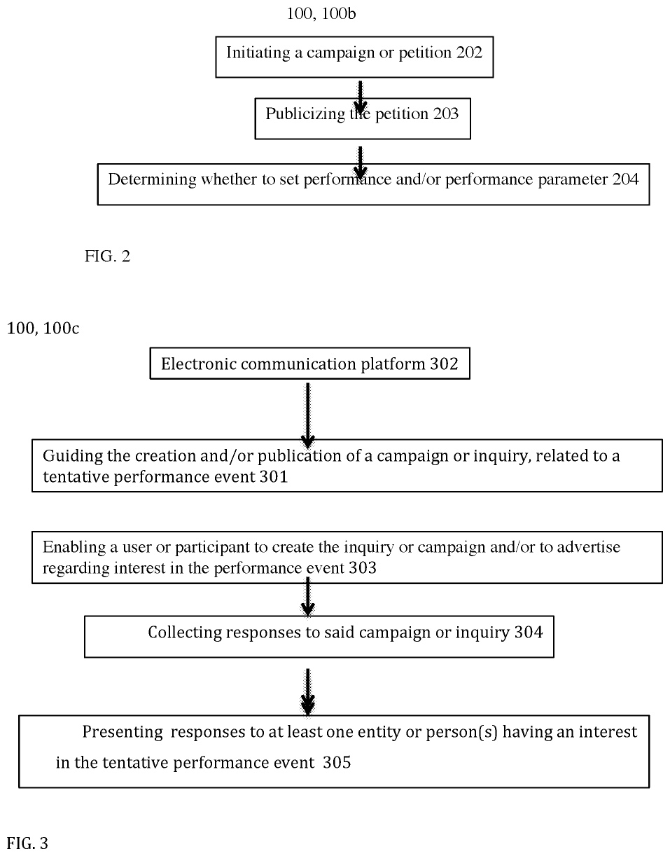

In FIG. 2, a method and system 100b, according to another embodiment of the disclosed method and system 100 for setting a performance event is shown. According to various embodiments, method/ system 100, 100b may comprise initiating a campaign or petition by at least one fan or other entity (such as a performance venue, stadiums, arenas, etc.), wherein the petition invites or requests a specific artist to perform (e.g. at the fan's town, specific venue, etc.). Such petition may be similar to step 102 of creating an NPP inquiry. In embodiments, the method 100 may further comprise a step 203 of publicizing the petition in order to get responses from fans and/or the performers themselves, which is similar to step 103 of publicizing the NPP inquiry; and a step 204 of determining whether or not a performance will take place and/or determining a parameter for setting the event based on the received responses, similar to step 104.

In various embodiments, according to step 202 fans in any locale may initiate their own “petitions” to have an artist performance come to their preferred venue (e.g. home town) for a show. In further embodiments, venue operators seeking to book a well-attended show, may themselves start a petition.

According to various embodiments, a petition can be publicized and shared, according to step 203, through various electronic communication platforms, including host forum 106 and/or individualized communication platforms 108.

In some embodiments, the host forum of the system/ method 100 may enable a petition and/or NPP inquiry to be initiated through the host forum then disseminated though various publication outlets. In some embodiments, a performing artist(s) may be enrolled members of the system/method 100 and/or host forum. In some embodiments, membership of the artist may be required for a fan to be able to initiate a petition or NPP inquiry.

In some embodiments, fans themselves may publicize their petitions or NPP inquiry via host forum 106 and/or individualized communication platforms 108 (e.g. by sharing on social media, emailing to other fans, etc.). In other embodiments, the host entity may itself publicize a fan initiated petition/ inquiry. In some embodiments, a fan-initiated petition/ inquiry may be sent to the performer/ artist for approving publication. In some embodiments, a fan-initiated petition/inquiry may be communicated to the performer and/or taken up for publication on the host forum upon the performer's approval and/or upon receiving a certain number of positive fan feedbacks and/or indicated commitments.

For example, at least one fan(s) may initiate a petition on host forum 106 (website, app, etc.), and then share and publicize it on all outlets of social media. When the petition reaches a baseline number, the host forum may inform the band or its representative/management. The band may then opt to become a “member band” of the host forum for receiving automatic notification of the petition status, and to enable the band to follow the petition. In some embodiments, the band may also publicize the petition and/or convert the petition to a request for commitments.

In some embodiments, the host forum 106 may allow fans to start a petition, and to share the petition though their various social media accounts, email lists, etc. In some embodiments, the method 100 may enable petitions initiated by different fans for the same performing artist to merge into a single petition.

In embodiments, the host entity may require fans and/or artists to enroll as a prerequisite for initiating and/or viewing various campaigns and/or NPP inquiries or otherwise using the host platform. In some embodiments, enrolled fans may be provided with a login ID and/or password.

According to various embodiments, performers that participate in publication of a campaign and/or NPP inquiry may be required to pay the host entity a fee, and/or percentage (e.g. 10%) of the gross receipts from ticket sales, or a hybrid. In some embodiments, the host entity may receive a fee per ticket commitment and/or ticket sale (e.g. the ticket commitment may include a set fee to host entity, which may be contingent on the performance taking place).

In some embodiments, fans may be charged a membership fee for enrollment/ ability to participate in the method 100, which may include receiving various incentives, such as early or guaranteed ticket purchase options, ability to start petitions, etc.

In some embodiments, a venue which initiates a petition or inquiry may pay the host entity a fee, which may be, for example, a percentage of profits from the performance, and/or a flat fee, e.g. a base level guarantee, and/or a fee based on the amount of tickets sold, according to various embodiments. In embodiments, this payment may be contingent on the performance taking place.

Additionally, the disclosed method/ system may incentivize fans to publicize and thus provide efficient/ cost effective advertising for a performance. While fans may naturally have incentive to publicize a potential performance they would like to attend, other incentives may also be offered, such as ticket discounts, early purchase options, etc. In some embodiments, the host forum may enable fans to share or publicize their interest or commitments to attend a show. In embodiments, the host forum may provide direct links (Share links) to social media platforms such as Face Book®, Twitter®, Instagram® etc. . . . ). The host forum may also enable the performing artist to encourage fans to publicize campaigns, and may further be linked to the artists' social media pages and other personal platforms.

Thus, the disclosed method/systems allows a performing artist and/or its representatives to start a campaign designed gauge fan interest or obtain fan engagement or commitment, which may range from having fans publicize or share their interest via the fan's own communication platform (e.g. Social media, email, etc.), to actually placing a partial or full deposit towards potential purchase of tickets (contingent on the show being set). In embodiments, the artist may set minimum threshold(s) of commitments and/or responses, and the like, as an obligating criteria for setting the performance. (e.g. the artist may require 2,000 ticket commitments to or 5,000 “interested” people, thinking a percentage of those will convert to ticket sales, according to the artist's discretion).

In embodiments, the disclosed method may be associated with merchandise sales and may be used to increase sales using incentives. For example, the host forum may be linked to a merchandise sales webpage and/or may offer incentives for purchase of merchandise associated with the performance. As another example, vouchers towards the purchase of merchandise associated with a performance may be given based on ticket purchases, deposits/partial deposits towards purchases, and/or commitments to purchase. Additionally, fans may be allowed to purchases merchandise associated with a show (e.g. new tour shirts, hats, etc.) before the show. A link to the merchandise store may be accessible via the host forum, according to various embodiments.

In some embodiments, fans may be given a say in determining an opening act, or co-headliner. For example, a poll including different possible options, or an invitation for fans to provide their comments in an NPP inquiry may be used to determine which combination may result in more ticket sales.

FIG. 3 illustrates a further embodiment of a method/system 100c, according to another embodiment of the disclosed method and system 100 for setting a performance event. In embodiments, method and system 100, 100c may comprise a first step 301 of guiding the creation and/or publication of a campaign or inquiry, related to a tentative performance event. In embodiments, the campaign or inquiry is publicized, wherein responses to the campaign or inquiry are collected. In further embodiments, a determination as to whether to set the tentative performance event and/or a parameter of the tentative performance event may be determined based on the collected responses. According to various embodiments, the inquiry or campaign may be created and publicized via at least one electronic communication platform 302 configured for implementing and carrying out method 100c. Such electronic communication platform 302 may enable a user seeking to create a campaign or inquiry to provide information related to the campaign or inquiry for the purpose of having the campaign or inquiry publicized. In embodiments, the campaign or inquiry may be publicized via a network communication forum, such as a website, webpage, app, etc., which may be operated by the host entity, via an individualized communication forum such as email, text messaging, social media, and/or third party advertising platforms (e.g. websites allowing advertising, pop-up ads, etc.), and the like.

In some embodiments, the method further comprises 303 enabling a user or participant to create the inquiry or campaign and/or to advertise regarding interest in the performance event. The user or participant may be a fan, performing artist(s) associated with the performance event or a representative of the performing artist, and/or a third party who has a business interest in the performance event.

In some embodiments, participation or membership status may be required for enabling the user to create the inquiry or campaign. In embodiments, membership status and/or enablement to create the inquiry or campaign by a fan may be established, for example, by payment of a fee to the host entity, providing personal information such as email, social media account, personal information useful for ad targeting, etc. In some embodiments, membership status and/or enablement to create the inquiry or campaign by an entity having a business interest in the performance (i.e. performing artist or representative, business owner such as a venue operator, etc.) may be established, for example, by payment of a fee to the host entity, agreeing to a fee based on profits earned from the event. In some embodiments, the host entity may require the creator of the campaign or inquiry to share or advertise the inquiry/campaign, prior to publication by the host entity. For example, publication may be contingent upon reaching a certain number of shares, and/or obtaining responses, such as ‘likes,’ etc., according to various embodiments. Other criteria/requirement(s) for enabling a user to create and/or advertise the inquiry or campaign, which may be set by the host entity may include approval by a performing artist associated with the performance event, or representative thereof and/or host entity; commitment of the user to purchase a ticket concerning the performance event, and/or share the inquiry/campaign, etc.

In some embodiments, the inquiry/campaign may solicit commitments towards ticket purchases should the tentative performance event be set, wherein the commitments may comprise full or partial payment for a ticket, providing payment information (e.g. credit card number) by the user, which can be used for collecting payment should the performance event be scheduled, or other criteria, which may contractually obligate a user. In embodiments, incentives may be offered for commitments towards ticket purchases, such as discounted tickets, early ticket purchase options, better seats, coupons for purchases at the performance event, e.g. for food and drink, and/or ability to purchase event related merchandise, etc.

For example, the host forum may enable users who respond to the inquiry or campaign, and/or users who commit to purchase a ticket, the ability to purchase merchandise related to the performance. This may be, for example, though the host forum and/or through a link to a merchandize sales forum. In some embodiments, users may be provided with a special code for enabling the purchase of event merchandise prior to the event, and/or for a discount.

In embodiments, method 100c may further comprise step 304 of collecting responses to the campaign or inquiry 304, wherein a determination as to whether to set the tentative performance event and/or a parameter of the tentative performance event may be determined based on the collected responses to the campaign or inquiry.

In embodiments, method 100c may further comprise a step 305 of presenting received responses to at least one entity or person(s) having an interest in the tentative performance event, such as the performing artist or representative thereof, a third party having a business interest in the performance event, and/or a fan who may be interested in attending the performance. For example, results may be presented via the electronic communication platform 302, which may be viewable by fans and/or member participants. According to various embodiments, the results may be presented as they are received in real time or periodically. In some embodiments, the campaign or inquiry may provide a response goal which serves to obligate the performing artist to set a performance should the response goal be met. In embodiments, such response goal may be set and/or approved by the performing artist and/or representative thereof. This may serve to drum up interest and excitement towards the event, with the goal of increasing ticket purchases.

The disclosed system and method 100 may be implemented though various devices (computer, phone, Tablet, etc.) capable of running computer software and/or hardware for implementing method 100. The methods, systems, process flows and logic of disclosed subject matter associated with a computer readable medium may be described in the general context of computer-executable instructions, such as, for example, program modules, which may be executed by a computer. Generally, program modules may include routines, programs, objects, components, data structures, etc. that perform particular tasks or implement particular abstract data types. The disclosed subject matter may also be practiced in distributed computing environments wherein tasks are performed by remote processing devices that are linked through a communications network. In a distributed computing environment, program modules may be located in local and/or remote computer storage media including memory storage devices.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for setting a performance event, comprising:
guiding the creation of a campaign or inquiry, said campaign or inquiry being related to a tentative performance event,
wherein said campaign or inquiry is publicized,
wherein responses to said campaign or inquiry are collected, and
wherein a determination as to whether to set the tentative performance event and/or a parameter of the tentative performance event is determined based on the collected responses to said campaign or inquiry,
and wherein the inquiry or campaign is created and publicized via at least one electronic communication platform.

2. The method of claim 1, further comprising enabling a user or participant to create said inquiry or campaign and/or to advertise regarding interest in the performance event, wherein said user may be a fan, a performing artist(s) associated with the performance event or a representative thereof, a third party who has a business interest in said performance event, or combinations thereof.

3. The method of claim 1, further comprising obtaining commitments towards ticket purchases should the tentative performance event be set.

4. The method of claim 1, further comprising offering incentives for commitments towards ticket purchases.

5. The method of claim 1, further comprising creating and publicizing the campaign or inquiry, via at least one of a network communication forum, individualized communication forum, or combination thereof.

6. The method of claim 1, further comprising incentivizing merchandise sales related to the performance event via enabling users to access a merchandise sales platform through said at least one electronic communication platform.

7. The method of claim 1, wherein said inquiry or a campaign is publicized via social media of at least one user, individualized communication forum, network forum supported by a host entity, a third party network forum or combinations thereof.

8. A system for setting a performance event comprising providing an electronic communication network forum configured for implementing a method comprising:
collecting information regarding fan interest related to a potential performance event via at least one electronic communication platform,
wherein said collecting information comprises creating an inquiry or campaign regarding the performance event, and publicizing the inquiry or campaign, said inquiry or campaign configured to obtain information regarding interest in the performance event; and
determining, based on information received in response to said inquiry or campaign, whether to set the performance event, and/or a parameter of the performance event.

9. The system of claim 8, wherein said electronic communication network forum enables users to purchase merchandise related to the performance event.

10. The system of claim 8, said method further comprising enabling a user of the forum to create and/or advertise the inquiry or campaign, subject to meeting qualifying criteria for doing so, wherein said qualifying criteria comprises at least one of:
a) approval by a performing artist associated with the performance event, or representative thereof;
b) membership status of the user;
c) commitment of the user to purchase a ticket concerning the performance event;
d) approval of the host entity;
e) providing personal information by the user;
f) payment of fee; and
g) combinations thereof.

11. A method for setting a performance event, comprising:
guiding the creation and/or publication of a campaign or inquiry via at least one electronic communication platform, said campaign or inquiry being related to a tentative performance event;
collecting responses to said campaign or inquiry; and
presenting said responses to at least one entity or person(s) having an interest in the tentative performance event, wherein said entity or person(s) having an interest in the tentative performance event comprises a performing artist associated with the performance event and/or representative thereof, a party having a business interest in the tentative performance event, members of the general public including fans of the performing artist, or combinations thereof.

12. The method of claim 11, wherein a determination as to whether to set the tentative performance event and/or a parameter of the tentative performance event is determined based on the collected responses to said campaign or inquiry.

13. The method of claim 11, further comprising obtaining commitments towards ticket purchases should the tentative performance event be set.

14. The method of claim 13, further comprising offering incentives for commitments towards ticket purchases.

15. The method of claim 11, wherein guiding the creation and/or publication comprises providing an electronic communication platform through which a user seeking to create said campaign or inquiry may provide information related to the campaign or inquiry for the purpose of having the campaign or inquiry publicized.

16. The method of claim 11, further comprising publicizing the campaign or inquiry through at least one electronic communication forum including a network communication forum controlled by a host entity.

17. The method of claim 16, further comprising publicizing the campaign or inquiry through email, text messaging, social media, pop-up ads, or combinations thereof, and wherein publicizing may be performed by said host entity, a creator of the campaign or inquiry, and/or other entity with an interest in the performance event.

18. The method of claim 11, further comprising obtaining approval from a performing artist associated with the performance event and/or representative thereof, prior to publicizing the inquiry or campaign.

19. The method of claim 11, further comprising presenting said responses via said at least one electronic communication platform, wherein the results are viewable by fans, and wherein the results are presented as they are received in real time or periodically.

20. The method of claim 11, wherein the campaign or inquiry provides a response goal which serves to obligate the performing artist associated with the performance event and/or representative thereof, to set a performance should the response goal be met.
